(19) United States
(12) Patent Application Publication
(10) Pub. No.: US 2004/0039855 A1
(43) Pub. Date: Feb. 26, 2004

(54) System and method for precisely locating networked devices

(75) Inventors: Patrick Joseph Bohrer, Austin, TX (US); Ramakrishnan Rajamony, Austin, TX (US); Hazim Shafi, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY

(21) Appl. No.: 10/227,520

(22) Filed: Aug. 22, 2002

(51) Int. Cl. G06F 13/12

(52) U.S. Cl. 710/62

(57) ABSTRACT

A networked device and system are disclosed wherein the networked device includes a network communication adapter and location information means. The adapter is configured to communicate with an external agent via a network to which the networked device is connected. The location information means is a part of or accessible to the network communication adapter and is configured to provide location information to the adapter where the location information is indicative of the adapter's geographic location. The adapter responds to a predetermined request from the external agent by providing the location information to the external agent. The location information means may include a global positioning system (GPS) receiver that is able to receive GPS signals and determine geographic information from the signals. In another embodiment, the location information means includes an ultra wideband (UWB) receiver that is able receive UWB signals. In a low cost embodiment suitable for use with fixed location devices, the location information means may comprise a simple storage element in which geographic location information is recorded. The network communication adapter is typically further configured to return location information to a requesting program executing on the networked device.

### BACKGROUND

1. Field of the Present Invention

The present invention generally relates to the field of networked devices and more particularly to a method and system in which networked devices employ location determination hardware in conjunction with a network communication adapter to enable precise location of the networked device.

2. History of Related Art

Networked devices including network servers, desktop machines, wireless personal data administrators (PDA's), web-enabled phones, and the like, are found in almost every conceivable consumer, business, educational, and governmental application. In some applications, a large number of systems are located in a relatively small environment. Internet data centers, for example, may include rack upon rack of server systems located within a single office or group of offices. Within a networked environment, each of the individual systems may have a unique identifier such as an IP address or, in an Ethernet environment, a Media Access Control (MAC) number. While these identifiers may be useful to identify systems electronically, it is frequently desirable from a systems administration perspective to be able to correlate an electronic or network identifier with a physical machine and to determine the physical location of that machine. Alternatively, it may be desirable for an application executing on a machine to determine its geographic location, particularly in the context of networked communication. It would be desirable to implement a system that enabled access to accurate geographic information. It would be further desirable if the implemented solution did not mandate substantial modifications to existing software modules.

### SUMMARY OF THE INVENTION

The problems identified above are in large part addressed by a network device and system that employ location determination hardware within a network communication adapter to facilitate the exchange of geographic position information corresponding to devices within a network. The networked device includes a network communication adapter and location information means. The adapter is configured to communicate with an external agent via a network to which the networked device is connected. The location information means is a part of or accessible to the network communication adapter and is configured to provide location information to the adapter. The location information is indicative of the geographic location of the location information means. Because the location information means is typically located on the adapter or some other suitable component of the networked device (a motherboard, for example), the location information is indicative of the location of the networked device. The adapter responds to a predetermined request from the external agent by providing the location information to the external agent. The location information means may include a global positioning system (GPS) receiver that is able to receive GPS signals and determine geographic information from the signals. In another embodiment, the location information means includes an ultra wideband (UWB) receiver that is able receive UWB signals. In a low cost embodiment suitable for use with fixed location devices, the location information means may comprise a simple storage element in which geographic location information is recorded. The network communication adapter is typically further configured to return location information to a requesting program executing on the networked device.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a networked device according to one embodiment of the present invention;

FIG. 2 is a block diagram of selected elements of a network communication adapter according to one embodiment of the present invention;

FIG. 3 is a block diagram of networked devices within a system enabled to determine physical locations of each networked device; and

FIG. 4A is a block diagram of selected components of a networked device according to the present invention in which an application is enabled to determine its geographic location;

FIG. 4B is a diagram of a network packet formatted to include geographic information according to one embodiment of the invention; and

FIG. 5 is a block diagram of selected elements of a network communication adapter according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates a networked device that incorporates location detection hardware in conjunction with a network communication adapter to enable the networked device and external devices connected to the networked device to determine the networked device's physical location or geographic position. The network communication adapter includes location determination hardware capable of receiving and interpreting information, such as the signals transmitted by global positioning system satellites, from which geographic location information can be derived. The network communication adapter is typically configured to recognize a predetermined network packet and, in response, to respond by returning geographic positioning information using the location determination hardware. In this manner, external agents connected to the system via a network can request the location of the system via a low level inquiry. In addition, application programs executing on the system may be enabled to access the location determination hardware via a software interface to incorporate geographic information into network requests or responses.

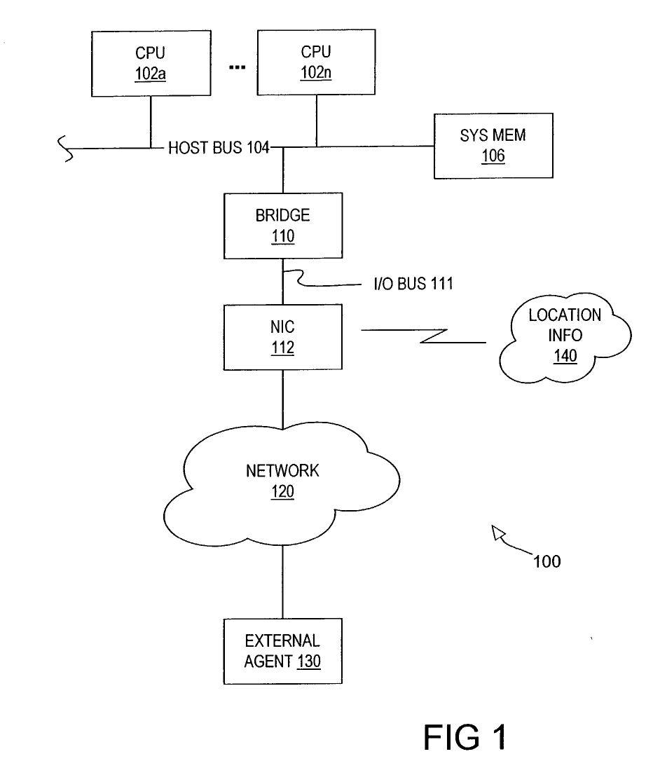

Turning now to the drawings, FIG. 1 is a block diagram of selected elements of a networked device 100 according to one embodiment of the present invention. The depicted embodiment of networked device 100 includes one or more central processing units 102a through 102n (generically or collectively referred to as CPU(s) 102). CPUs 102 are connected to a system memory 106 via a host bus 104. A bridge 110 provides an interface between host bus 104 and an I/O bus 111. I/O bus 111 may be implemented as a shared bus such as a PCI bus or, in other embodiments, exemplified by an Infiniband-type architecture, bridge 110 may include a switching device and I/O bus 111 is a point-to-point connection.

Networked device 100 is typically a network-aware device or system that includes some form of network communication adapter. In the depicted embodiment this network communication adapter is identified as network interface card (NIC) 112. NIC 112 is typically a network adapter that facilitates communication between host bus 104 and a network 120 to which one or more external agents 130 may be connected. According to the present invention, NIC 112 is configured to receive and process location information identified in FIG. 1 by reference numeral 140. More specifically, NIC 112 is configured to determine its absolute or relative physical or geographic location from location information 140.

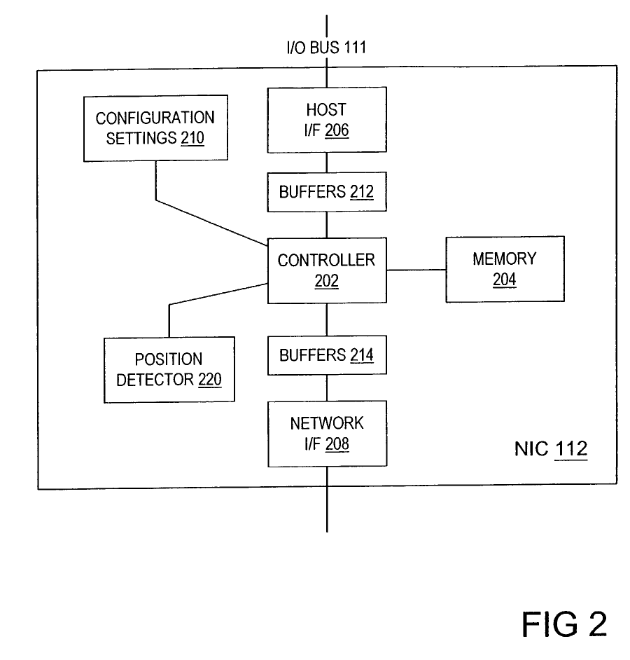

Referring now to FIG. 2, a block diagram of selected elements of a network communication adapter suitable for use as NIC 112 in FIG. 1 is presented. In this embodiment, NIC 112 includes a controller 202 having access to a local memory 204, a host interface 206, and a network interface 208. Controller 202 typically executes code stored within local memory 204, which may include a dynamic RAM portion as well as a non-volatile portion or device suitable for storing the controller's operating code. The operating code of controller 202 is configured to maintain various configuration settings 210 associated with the NIC. In addition, NIC 112 typically includes one or more buffers 212 and 214 used for temporary storage of network traffic to and from I/O bus 111.

According to the present invention, NIC 112 includes location determination hardware identified by reference numeral 220 that facilitates the determination of the NIC's geographic location. Location determination hardware 220 is configured to receive and interpret information from which geographic position can be determined. The geographic information signals are typically wireless signals with extremely precise timing information. In one embodiment, for example, location determination hardware 220 includes a global positioning system (GPS) receiver. As is known in the field, GPS is a system for determining geographic position anywhere on Earth. In the GPS, a set of satellites with extremely precise timing mechanisms are orbiting the Earth. At any position on Earth, a GPS receiver is theoretically capable of receiving signals from at least three of the satellites. From differences in the time at which each signal is received, a GPS receiver can triangulate its position on Earth.

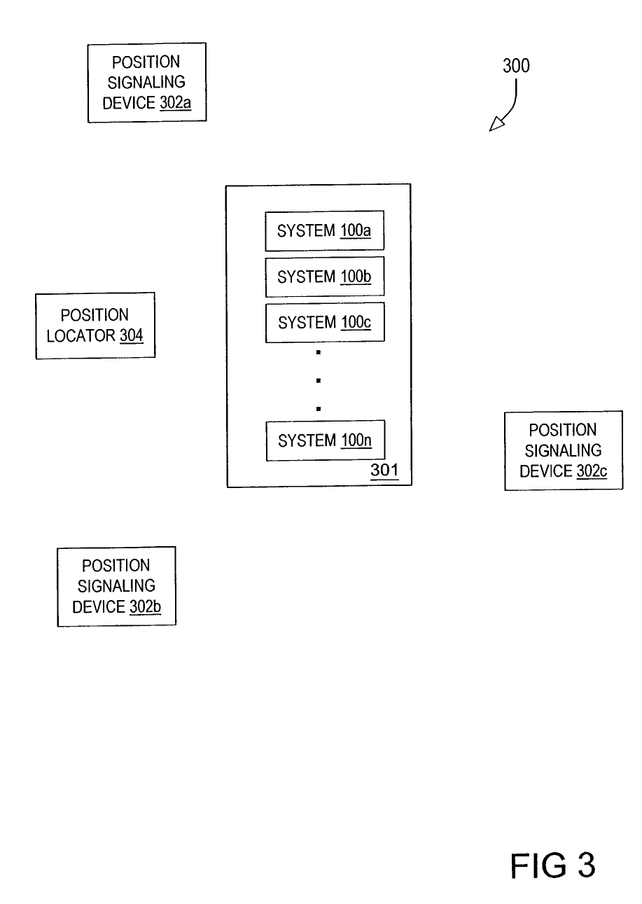

Referring to FIG. 3, selected elements of a system 300 for locating densely space devices according to one embodiment of the present invention is depicted. In this depiction, a building, room, or other structure 301 contains a plurality of networked devices 100a through 100n (generically or collectively networked device(s) 100). Each networked device 100 may represent a network server configured in substantially the same manner as the networked device 100 depicted in FIG. 1. This assembly of multiple networked devices in close physical proximity to one another is commonly encountered in an increasing number of applications including, for example, an Internet data center, educational implementations, process and development labs, and the like. In any of these applications, it may be important for a system technician or administrator to locate a particular networked device such as when one of the devices is malfunctioning. Although the NIC on each device has a unique number (such as the NIC's media access control number in an Ethernet implementation) and each device has a unique network address (such as its IP address in a TCP/IP implementation), these facilities are more helpful in finding a device electronically (i.e., via the network) than physically. While implementations in which a particular system is made to blink or issue a pinging sound in response to a network request have been proposed, these systems have limitations. A pinging sound, for example, is difficult to locate precisely and has a limited range. Moreover, such systems require a level of NIC functionality that may not always exist.

To address these problems, system 300 includes a plurality of networked devices 100a through 100n at least one of which includes location detection hardware 220 as illustrated in FIG. 1. One or more position signaling devices 302a through 302c (generically or collectively referred to as position signaling device(s) 302) transmit signals from which location determination hardware 220 on one or more networked device 100 can determine its geographic location. As indicated previously, the position signaling device(s) 302 may comprise the set of GPS satellites in orbit.

In instances where the obtainable resolution of conventional GPS or problems associated with receiving clear GPS signals within building 301 warrant it, position signaling devices 302 may comprise so-called pseudo-satellites or “pseudolites.” Pseudolites are ground based devices that transmit signals in the same format as GPS satellites. In other words, pseudolites transmit precisely controlled timing information in a GPS-like format. From such information, location determination hardware 220 is enabled to determine a relative physical location with a resolution or accuracy of less than a meter. Pseudolites capable of functioning in this manner are commercially available from vendors including Navicom (www navicom co kr).

System 300 as depicted in FIG. 3 may beneficially include a position locator, indicated by reference numeral 304, for tracking down a particular networked device. After obtaining physical location information corresponding to a particular networked device via the network as described herein, a field service technician, network administrator, or other user could employ position locator 304 to guide him or her to the corresponding location. Position locator 304 may comprise a hand-held GPS locator capable of displaying the user's current location.

In some embodiments, the physical location information may be conveyed and determined by means other than GPS. In one embodiment, for example, positioning signaling device(s) 302 may comprise an ultra wide-band (UWB) transmitter while signal and location detection hardware 220 may include a UWB receiver. UWB is a wireless technology for transmitting digital data over a wide spectrum of frequency bands at low power. UWB is also suitable for high-resolution radars and sub-centimeter radio location systems. Instead of traditional sine waves, UWB radio broadcasts digital pulses that are timed very precisely on a signal across a very wide spectrum at the same time. In this implementation position signaling device 302 and location determination hardware must be coordinated to send and receive pulses with an accuracy of trillionths of a second.

In an embodiment desirable for requiring negligible software reconfiguration, location determination hardware 220, in conjunction with the NIC controller 202, is configured to recognize a predetermined network packet as a request for location information. Analogous to the manner in which NIC cards are currently configured to respond to “wake on LAN” commands, this embodiment of the invention contemplates a low level request to which the hardware returns the desired position information. Thus, location determination hardware 220 may be configured to recognize specific network packets as requests to return the current geographic information. This embodiment facilitates the determination of a system's location by a network administrator who has information about the IP address or MAC number of a particular device, but no idea of where that device sits within a facility.

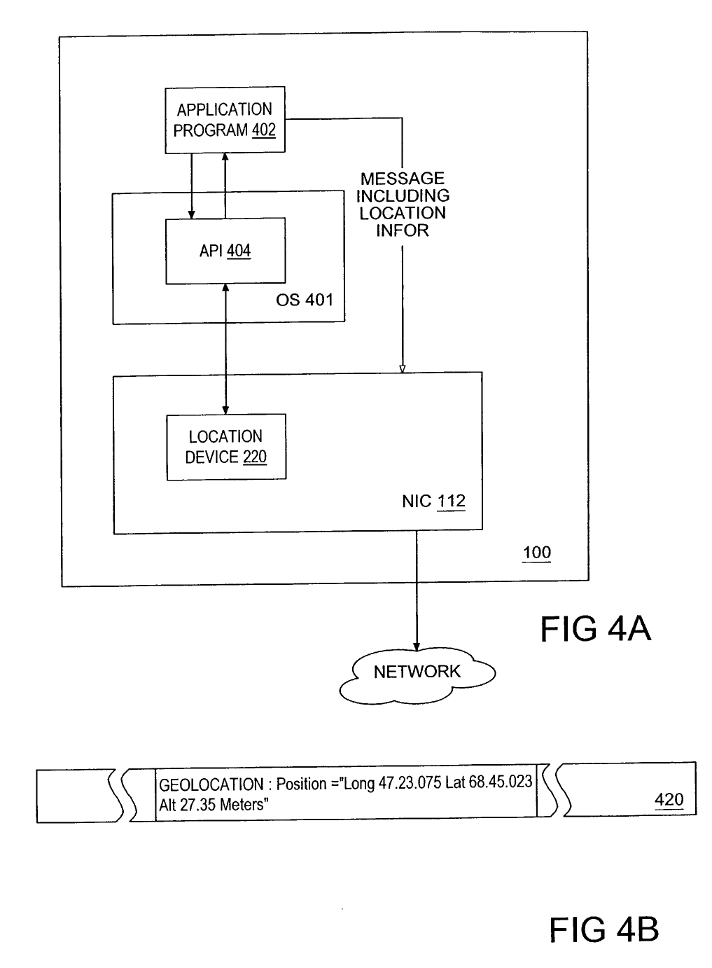

Referring now to FIGS. 4A and 4B, an embodiment of the present invention is depicted in block diagram format to illustrate the use of the information provided by NIC 112 in conjunction with an application program running on the system itself. In this embodiment, networked device 100 is shown as including, in addition to NIC 112 and location detection hardware 220, selected pieces of computer software. This software, as will be familiar to those skilled in the field of data processing systems generally, represents sets of computer executable instructions that are stored on a computer readable medium such as a hard disk, floppy diskette, CD ROM or the like. The depicted embodiment of networked device 100 includes operating system code identified by reference numeral 401, an application program interface (API) 404, and an application program 402. Operating system 401 is responsible for managing and scheduling multiple processes on the system, allocating and de-allocating (reclaiming) limited system memory, and other general maintenance tasks. Operating system 401 as depicted includes an API designed for use with location determination hardware 220. An application program 402 is configured to invoke API 404 to communicate with location determination hardware 220 and, more specifically, to retrieve the geographic information from the location determination hardware. Application program 402 might then beneficially incorporate this geographic information. Application program 402 might, for example, represents an HTTP compliant application such as a conventional web browser. In this embodiment, the application could query the location determination hardware 220 via API 404 and incorporate the retrieved position information into a message suitable for transmission over the network. This embodiment might be made compatible with existing HTTP implementations by incorporating the geographic information into an existing HTTP header field designed for use with new or unanticipated applications. The geographic information, might, for example, be embedded within the PRAGMA field in a standard HTTP header. In other implementations, an entirely new HTTP header field could be instituted for such purposes. FIG. 4B is a conceptual representation of an HTTP compliant packet 420 that implements an entirely new header field (the GEOLOCATION field) to convey the location information. By enabling applications running on the system to determine their position, the invention allows for application enhancements such as optimizing information to a specific geographic location.

Moreover, location determination hardware 220 gives each networked device 100 timing means of unparalleled accuracy. Because position determination systems such as GPS are based on extremely accurate clocks, networked devices with appropriate location determination hardware can determine, in addition to their geographic location, the time of day with great precision. Thus, each networked device 100 employing location determination hardware 220 is capable of coordinating or synchronizing its activities with other devices. If, for example, it were desirable to have all networked device perform an activity at the same time or at precisely controlled time intervals, location determination hardware 220 could function as a timing device that initiates the appropriate action on each networked device. Thus, one embodiment of the invention contemplates a method of synchronizing or otherwise coordinating activity among a set of networked devices by detecting GPS signals or the like with location determination hardware on each networked device.

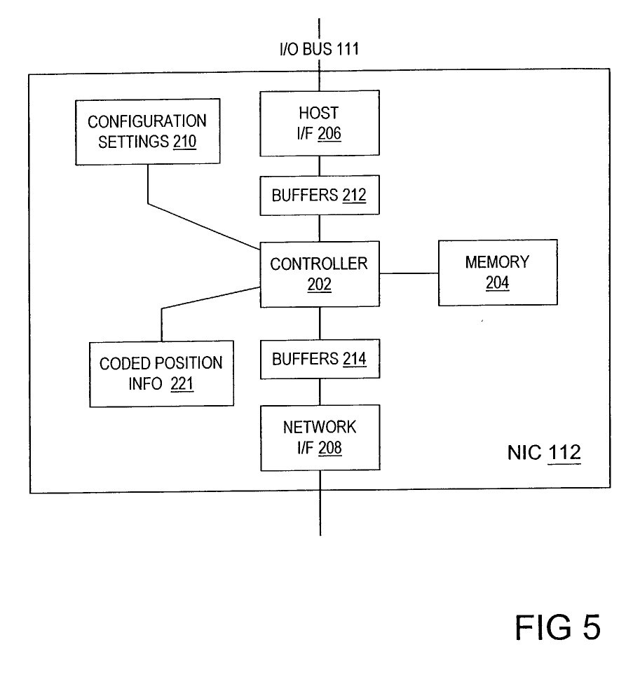

In an embodiment suitable for low cost applications, networked device 100 may employ a network interface adapter 112 containing a programmably coded physical or geographical location in lieu of location determination hardware. For applications in which networked device 100 is not likely to move frequently, coded geographic information provides the same location determination functionality without the expense of a GPS receiver or other similar hardware. Referring to FIG. 5, an embodiment of network communication adapter 112 including a programmably coded physical location is depicted. In this embodiment, adapter 112 includes substantially the same elements as described previously with respect to FIG. 2. Instead of location determination hardware 220 as shown in FIG. 2, however, NIC 112 as depicted in FIG. 5 includes programmable coded information 221 indicating the NIC's geographic location. Coded information 221 is typically stored in a persistent or non-volatile storage cell or memory device such as a flash memory device. As such, programmably coded information 221 may be reprogrammed on an as-needed basis. The programmably coded information could be programmed, for example, by determining the device's location via a hand-held GPS device and then supplying the GPS information to the adapter over the network with a special “write location” command (that NIC 112 would be configured to recognize). NIC 112 as depicted in FIG. 5 would still function by responding to the appropriate request with geographic information. Instead of obtaining the geographic information via GPS or other location detection hardware, the NIC would access its locally stored geographic information.

It will be apparent to those skilled in the art having the benefit of this disclosure that the present invention contemplates a system for providing location information associated with a networked device. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A networked device, comprising:
a network communication adapter configured to communicate with an external agent via a network to which the networked device is connected;
location information means accessible to the network communication adapter and configured to provide location information to the adapter indicative of the geographic location of the location information means; and
wherein the network communication adapter is configured to respond to a predetermined request from the external agent by providing the location information to the external agent.

2. The networked device of claim 1, further comprising at least one processor connected to the adapter via an I/O bus and a system memory accessible to each of the at least one processors.

3. The networked device of claim 1, wherein the location information means comprises a global positioning system (GPS) receiver enabled to receive GPS signals and to determine geographic information from the signals.

4. The networked device of claim 1, wherein the location information means comprises an ultra wideband (UWB) receiver enabled to receive UWB signals and to determine geographic information from the signals.

5. The networked device of claim 1, wherein the location information means comprises a storage element in which geographic location information is recorded.

6. The networked device of claim 1, wherein the network communication adapter is further configured to return the location information to a requesting program executing on the networked device.

7. The networked device of claim 1, wherein the network communication includes hardware means for responding to the predetermined request with the location information.

8. A networked system, comprising:
means for providing signals from which the geographic position of a receiver can be determined;
a networked device including a network communication adapter configured to communicate with an external agent via a network to which the networked device is connected, the adapter further comprising location information means accessible to the network communication adapter and configured to provide location information to the adapter indicative of the adapter's geographic location; and
wherein the network communication adapter is configured to respond to a predetermined request from the external agent by providing the location information to the external agent.

9. The system of claim 8, further comprising at least one processor connected to the adapter via an I/O bus and a system memory accessible to each of the at least one processors.

10. The system of claim 8, wherein the location information means comprises a global positioning system (GPS) receiver enabled to receive GPS signals and to determine geographic information from the signals.

11. The system of claim 8, wherein the location information means comprises an ultra wideband (UWB) receiver enabled to receive UWB signals and to determine geographic information from the signals.

12. The system of claim 8, wherein the location information means comprises a storage element in which geographic location information is recorded and further wherein the network communication adapter is configured to write the location information into the storage element responsive to a predetermined network request.

13. The system of claim 8, wherein the network communication adapter is further configured to return the location information to a requesting program executing on the networked device.

14. The system of claim 8, wherein the network communication includes hardware means for responding to the predetermined request with the location information.

15. A network interface adapter, comprising;
a controller configured to communicate with a network and with a peripheral bus of a host system;
local memory accessible to the controller; and
location information means accessible to the controller and configured to provide location information responsive to receipt of a predetermined network request by the controller.

16. The network interface adapter of claim 15, wherein the location information means comprises a global positioning system (GPS) receiver enabled to receive GPS signals and to determine geographic information from the signals.

17. The network interface adapter of claim 15, wherein the location information means comprises an ultra wideband (UWB) receiver enabled to receive UWB signals and to determine geographic information from the signals.

18. The networked interface adapter of claim 15, wherein the location information means comprises a storage element in which geographic location information is recorded.

19. The network interface adapter of claim 15, wherein the network communication adapter is further configured to return the location information to a requesting program executing on the networked device.

20. The network interface adapter of claim 15, wherein the network communication includes hardware means for responding to the predetermined request with the location information.
